(19) United States
(12) Patent Application Publication
(10) Pub. No.: US 2024/0323680 A1
(43) Pub. Date: Sep. 26, 2024

(54) APPARATUSES AND COMMUNICATION METHODS OF KEY GENERATION

(71) Applicant: INNOPEAK TECHNOLOGY, INC., Palo Alto, CA (US)

(72) Inventor: Marcus WONG, Palo Alto, CA (US)

(21) Appl. No.: 18/601,482

(22) Filed: Mar. 11, 2024

Related U.S. Application Data
(60) Provisional application No. 63/454,585, filed on Mar. 24, 2023.

(51) Int. Cl. H04W 12/041; H04W 12/03

(52) U.S. Cl. CPC H04W 12/041; H04W 12/03

(57) ABSTRACT

A wireless communication method of key generation by an ambient internet-of-things (AIOT) device includes obtaining a first physical layer key used in at least one previous communication with a node, using the first physical layer key as an input of a physical layer key generator, and obtaining a second physical layer key generated based on at least a part of the first physical layer key, wherein the second physical layer key is an output of the physical layer key generator.

### CROSS-REFERENCE TO RELATED APPLICATIONS

This application claims the benefit of priority to U.S. Provisional Application No. 63/454,585, entitled “METHOD FOR LOOP FEEDBACK PHYSICAL LAYER SHARED KEY GENERATION IN A COMMUNICATION SYSTEM,” filed on Mar. 24, 2023, which is hereby incorporated by reference in its entirety.

### TECHNICAL FIELD

The present disclosure relates to the field of communication systems, and more particularly, to apparatuses and wireless communication methods of key generation such as apparatuses and wireless communication methods for loop feedback physical layer shared key generation in a communication system.

### BACKGROUND

5th generation (5G) ambient internet-of-things (AIoT) service can be used to support various use cases such as, automated warehousing, inventory management, smart grid, non-public logistics, manufacturing, internet-of-things (IoT) sensors, and smart home device, etc.

An AIoT device lacks a conventional battery and is, instead, powered by energy harvesting. Energy harvested by AIoT devices typically relies on wireless radio waves, solar energy, and/or other types of light, motion/vibration, heat, pressure, or any other power sources. As a result, AIoT device can communicate with a 5G user equipment (UE) or a 5G base station (BS). Security is important to protect network connections and data that could potentially be at risk of being exposed and sabotaged, even for no-powered devices, low-powered devices, or near-zero-powered devices such an AIoT devices. Other terminologies such as Passive IoT (PIoT), zero-powered IoT, low-powered IoT are synonymous with AIoT.

Therefore, there is a need for apparatuses and wireless communication methods of key generation such as apparatuses and wireless communication methods for loop feedback physical layer shared key generation in a communication system.

### SUMMARY

An object of the present disclosure is to propose apparatuses and wireless communication methods of key generation such as apparatuses and wireless communication methods for loop feedback physical layer shared key generation in a communication system, which can provide security of communication between an AIoT device and a node.

In a first aspect of the present disclosure, a wireless communication method of key generation by an ambient internet-of-things (AIoT) device includes obtaining a first physical layer key used in at least one previous communication with a node, using the first physical layer key as an input of a physical layer key generator, and obtaining a second physical layer key generated based on at least a part of the first physical layer key, wherein the second physical layer key is an output of the physical layer key generator.

In a second aspect of the present disclosure, a wireless communication method of key generation by a node includes obtaining a first physical layer key used in at least one previous communication with an ambient internet-of-things (AIoT) device, using the first physical layer key as an input of a physical layer key generator, and obtaining a second physical layer key generated based on at least a part of the first physical layer key, wherein the second physical layer key is an output of the physical layer key generator.

In a third aspect of the present disclosure, an ambient internet-of-things (AIoT) device includes an obtainer and an inputter. The obtainer is configured to obtain a first physical layer key used in at least one previous communication with a node. The inputter is configured to use the first physical layer key as an input of a physical layer key generator, and the obtainer is further configured to obtain a second physical layer key generated based on at least a part of the first physical layer key, and the second physical layer key is an output of the physical layer key generator.

In a fourth aspect of the present disclosure, an ambient internet-of-things (AIoT) device includes a memory, a transceiver, and a processor coupled to the memory and the transceiver. The AIoT device is configured to perform the above method.

In a fifth aspect of the present disclosure, a node includes an obtainer and an inputter. The obtainer is configured to obtain a first physical layer key used in at least one previous communication with an ambient internet-of-things (AIoT) device. The inputter is configured to use the first physical layer key as an input of a physical layer key generator, and the obtainer is further configured to obtain a second physical layer key generated based on at least a part of the first physical layer key, and the second physical layer key is an output of the physical layer key generator.

In a sixth aspect of the present disclosure, a node includes a memory, a transceiver, and a processor coupled to the memory and the transceiver. The node is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of an example of ambient internet-of-things (AIoT) communication system.

FIG. 2 is a block diagram of a user equipment (UE), a base station (BS), and an AIoT device of communication in a communication system according to an embodiment of the present disclosure.

FIG. 3 is a block diagram of an AIoT device according to an embodiment of the present disclosure.

FIG. 4 is a block diagram of an AIoT device according to an embodiment of the present disclosure.

FIG. 5 is a flowchart illustrating a wireless communication method of key generation performed by an AIoT device according to an embodiment of the present disclosure.

FIG. 6 is a block diagram of a node according to an embodiment of the present disclosure.

FIG. 7 is a block diagram of a node according to an embodiment of the present disclosure.

FIG. 8 is a flowchart illustrating a wireless communication method of key generation performed by a node according to an embodiment of the present disclosure.

FIG. 9 is a block diagram of an example of a loop feedback physical layer key generation in an AIoT communication system according to an embodiment of the present disclosure.

FIG. 10 is a block diagram of an example of a loop feedback physical layer key generation in an AIoT communication system according to an embodiment of the present disclosure.

FIG. 11 is a block diagram of an example of a computing device according to an embodiment of the present disclosure.

FIG. 12 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a future 5th generation (5G) system (may also be called a new radio (NR) system), an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), or other communication systems, etc.

Optionally, a user equipment (UE) mentioned in the embodiments of the present application may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum, or the communication system in the embodiment of the present application may also be applied to a licensed spectrum, where the licensed spectrum can also be considered an unshared spectrum.

Various published solutions describe schemes that rely on various characteristics of wireless channel reciprocity to derive shared keys between two communicating entities. The two communicating entities are for example, an ambient internet-of-things (AIoT) device and a node. The node is for example, a UE or a base station (BS). Some of the characteristics used are signal strength, channel impulse response, channel state information, etc. Common bits are then extracted from combination of information, such as wireless channel information or parameter measurements only present in communication between the two communicating entities and only the two communicating entities in proximity are able to extract. Once sufficient number of bits (e.g., 128 or 256) are extracted, these bits form a shared secret key and can be used by the two communicating entities to protect the information being exchanged between them over the air.

Combining physical layer key generation and using additional input reduces the time at which the number of bits (e.g., 128, 256, etc.) can be generated in a shorter period of time to be used to secure communication between communicating entities.

Some drawbacks are present in the physical layer key generation. One drawback in the physical layer key generation includes a problem with the typically available input parameters (e.g., system time, nonce, device ID, counter, etc.) to the physical layer key generation: 1) system time may require an ambient internet-of-things (AIoT) device to maintain power in order to keep a system clock running continuously, 2) nonce requires that both nodes that generate the physical layer keys (e.g., AIoT device and UE/BS) to synchronize the generation of the nonce, 3) a device ID is static and does not change over time, and 4) a monotonically incremented counter requires both nodes to keep track of the current value and to increment after each use.

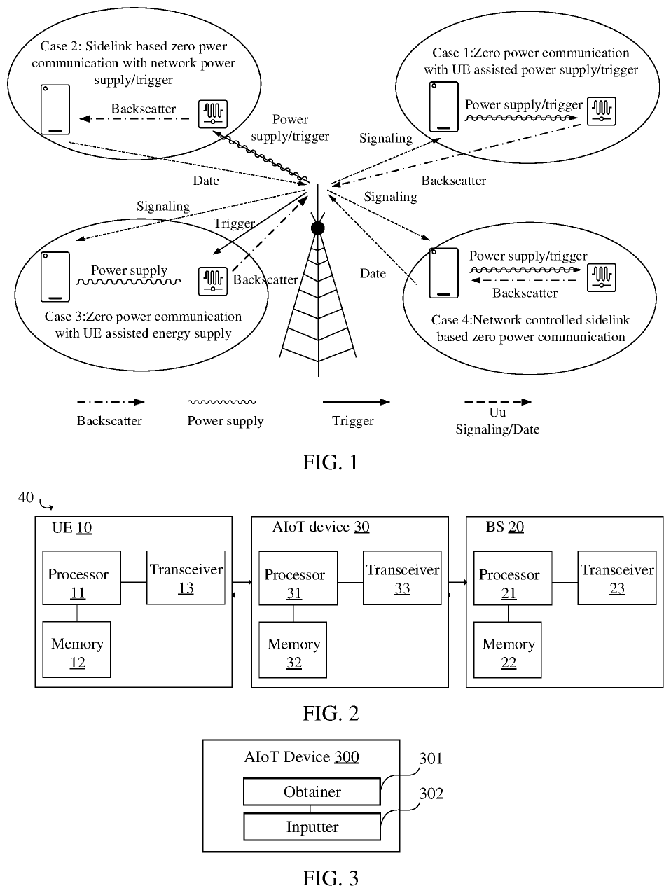

FIG. 1 is an example of ambient internet-of-things (AIoT) communication system. FIG. 1 illustrates that, in some embodiments, in the actual deployment of a zero-power communication system, a cellular and sidelink based zero-power communication system can also be flexibly coexisted or combined, so as to allow more potential application scenarios. The system block diagram of the hybrid of cellular and sidelink based zero-power communication system is as follows. It can include a variety of communication modes, for example, case 1, case 2, case 3, and case 4 as illustrated in FIG. 1.

Case 1: Zero-Power Communication with UE Assisted Power Supply/Trigger

In the case 1, a zero-power terminal is powered and triggered by an intelligent terminal in a network, and a backscatter signal of the zero-power terminal is received by a base station. A power supply and trigger operation of the intelligent terminal can be controlled by the base station through air interface signaling.

Case 2: Sidelink Based Zero-Power Communication with Network Power Supply/Trigger

In the case 2, a base station provides a wireless power supply and trigger signaling to a zero-power terminal. A backscatter signal of the zero-power terminal is received by an intelligent terminal to complete sidelink communication. Further, the intelligent terminal sends data to the base station.

Case 3: Zero-Power Communication with UE Assisted Energy Supply

In the case 3, a base station provides wireless a power supply and trigger signaling to a zero-power terminal. A backscatter signal of a zero-power terminal is received by an intelligent terminal to complete sidelink communication. Further, the intelligent terminal sends data to the base station. The intelligent terminal in a network provides auxiliary energy for the zero-power terminal. The base station sends trigger information to the zero-power terminal and receives the backscatter signal of the zero-power terminal. The intelligent terminal provides auxiliary energy supply for zero-power terminal, which can be controlled by the base station through air interface signaling.

### Case 4: Network Controlled Sidelink Based Zero-Power Communication

In the case 4, an intelligent terminal receives an air interface signaling and data of a network. The intelligent terminal supplies energy and triggers for a zero-power terminal, receives a backscatter signal of the zero-power terminal, and completes sidelink communication.

Security can be provided by a physical layer shared security key generation mechanism between an AIoT device and a node (such as a UE or a base station), which relies on wireless channel reciprocity of communication between the AIoT device and the node. The generated shared key then can be used to provide additional security service such as ciphering and integrity protection of the communication between the AIoT device and the node.

Some embodiments of the present disclosure improves on the use of wireless channel reciprocity to generate keys by providing loop feedback of previously generated shared key as an additional input during the communication, so that the shared security key generation can be achieved much faster.

FIG. 2 illustrates that, in some embodiments, a UE 10, a BS 20, and an AIoT device 30 of communication in a communication system 40. The communication system 40 includes the UE 10, the BS 20, and the AIoT device 30. The UE 10 may include a memory 12, a transceiver 13, and a processor 11 coupled to the memory 12 and the transceiver 13. The BS 20 may include a memory 22, a transceiver 23, and a processor 21 coupled to the memory 22 and the transceiver 23. The AIoT device 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the processor 31 is configured to obtain a first physical layer key used in at least one previous communication with a node (such as the UE 10 or the BS 20), use the first physical layer key as an input of a physical layer key generator, and obtain a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

In some embodiments, the processor 11 or 21 is configured to obtain a first physical layer key used in at least one previous communication with the AIoT device 30, use the first physical layer key as an input of a physical layer key generator, and obtain a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

FIG. 3 illustrates an AIoT device 300 according to an embodiment of the present disclosure. The AIoT device 300 is configured to implement some embodiments of the disclosure. Some embodiments of the disclosure may be implemented into the AIoT device 300 using any suitably configured hardware and/or software. The AIoT device 300 includes an obtainer 301 and an inputter 302. The obtainer 301 is configured to obtain a first physical layer key used in at least one previous communication with a node. The inputter 302 is configured to use the first physical layer key as an input of a physical layer key generator, and the obtainer 301 is further configured to obtain a second physical layer key generated based on at least a part of the first physical layer key, and the second physical layer key is an output of the physical layer key generator. This can solve issues in the prior art and other issues. Further, the proposed some embodiments can provide security of communication between an AIoT device and a node.

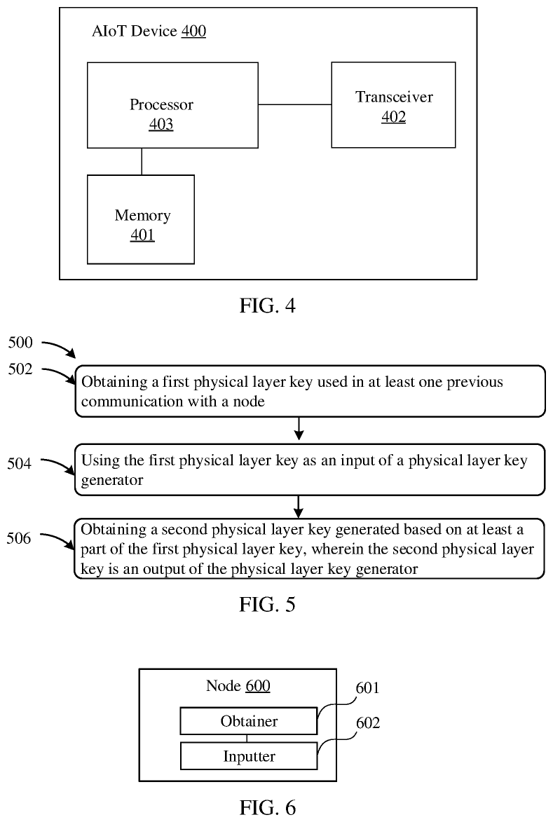

FIG. 4 illustrates an AIoT device 400 according to an embodiment of the present disclosure. The AIoT device 400 is configured to implement some embodiments of the disclosure. Some embodiments of the disclosure may be implemented into the AIoT device 400 using any suitably configured hardware and/or software. The AIoT device 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the processor 403 is configured to obtain a first physical layer key used in at least one previous communication with a node (such as a UE or a BS), use the first physical layer key as an input of a physical layer key generator, and obtain a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

FIG. 5 illustrates a wireless communication method 500 of key generation performed by an AIoT device according to an embodiment of the present disclosure. The wireless communication method 500 of key generation performed by the AIoT device is configured to implement some embodiments of the disclosure. Some embodiments of the disclosure may be implemented into the wireless communication method 500 of key generation performed by the AIoT device using any suitably configured hardware and/or software. In some embodiments, the wireless communication method 500 of key generation performed by the AIoT device includes: an operation 502, obtaining a first physical layer key used in at least one previous communication with a node, an operation 504, using the first physical layer key as an input of a physical layer key generator, and an operation 506, obtaining a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

In some embodiments, the physical layer key generator is a loop feedback physical layer key generation. In some embodiments, obtaining the second physical layer key includes preforming a randomization operation, a quantization operation, a reconciliation operation, and a shared key stream operation on the first physical layer key. In some embodiments, the second physical layer key is used as a one-time pad (OTP). In some embodiments, the wireless communication method further includes performing a channel establishment procedure with the node. In some embodiments, the wireless communication method further includes generating an encrypted message based on the second physical layer key. In some embodiments, the wireless communication method further includes sending the encrypted message to the node. In some embodiments, the node is a user equipment (UE) or a base station.

FIG. 6 illustrates a node 600 according to an embodiment of the present disclosure. The node 600 is configured to implement some embodiments of the disclosure. Some embodiments of the disclosure may be implemented into the node 600 using any suitably configured hardware and/or software. The node 600 includes an obtainer 601 and an inputter 602. The obtainer 601 is configured to obtain a first physical layer key used in at least one previous communication with an ambient internet-of-things (AIoT) device. The inputter 602 is configured to use the first physical layer key as an input of a physical layer key generator, and the obtainer 601 is further configured to obtain a second physical layer key generated based on at least a part of the first physical layer key, and the second physical layer key is an output of the physical layer key generator. This can solve issues in the prior art and other issues. Further, the proposed some embodiments can provide security of communication between an AIoT device and a node.

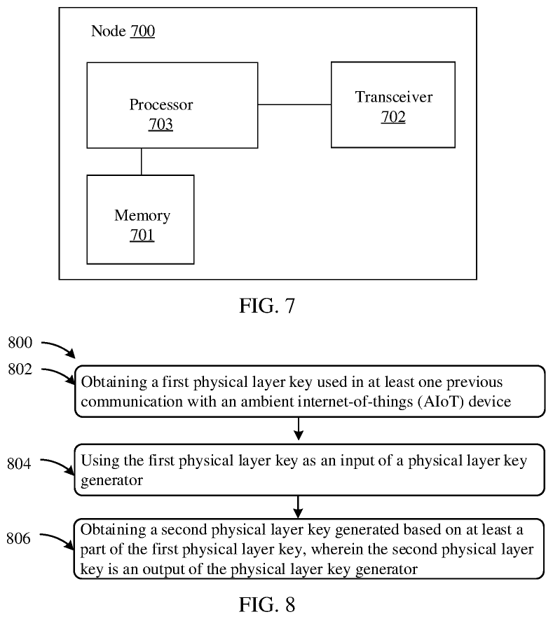

FIG. 7 illustrates a node 700 according to an embodiment of the present disclosure. The node 700 is configured to implement some embodiments of the disclosure. Some embodiments of the disclosure may be implemented into the node 700 using any suitably configured hardware and/or software. The node 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the processor 703 is configured to obtain a first physical layer key used in at least one previous communication with an ambient internet-of-things (AIoT) device, use the first physical layer key as an input of a physical layer key generator, and obtain a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

FIG. 8 illustrates a wireless communication method 800 of key generation performed by a node according to an embodiment of the present disclosure. The wireless communication method 800 of key generation performed by the node is configured to implement some embodiments of the disclosure. Some embodiments of the disclosure may be implemented into the wireless communication method 800 of key generation performed by the node using any suitably configured hardware and/or software. In some embodiments, the wireless communication method 800 of key generation performed by the node includes: an operation 802, obtaining a first physical layer key used in at least one previous communication with an ambient internet-of-things (AIoT) device, an operation 804, using the first physical layer key as an input of a physical layer key generator, and an operation 806, obtaining a second physical layer key generated based on at least a part of the first physical layer key, wherein the second physical layer key is an output of the physical layer key generator. This can solve issues in the prior art and other issues. Further, the proposed some embodiments can provide security of communication between an AIoT device and a node.

In some embodiments, the physical layer key generator is a loop feedback physical layer key generation. In some embodiments, obtaining the second physical layer key includes preforming a randomization operation, a quantization operation, a reconciliation operation, and a shared key stream operation on the first physical layer key. In some embodiments, the second physical layer key is used as a one-time pad (OTP). In some embodiments, the wireless communication method further includes performing a channel establishment procedure with the AIoT device. In some embodiments, the wireless communication method further includes receiving an encrypted message from the AIoT device. In some embodiments, the wireless communication method further includes decrypting the encrypted message based on the second physical layer key. In some embodiments, the node is a user equipment (UE) or a base station.

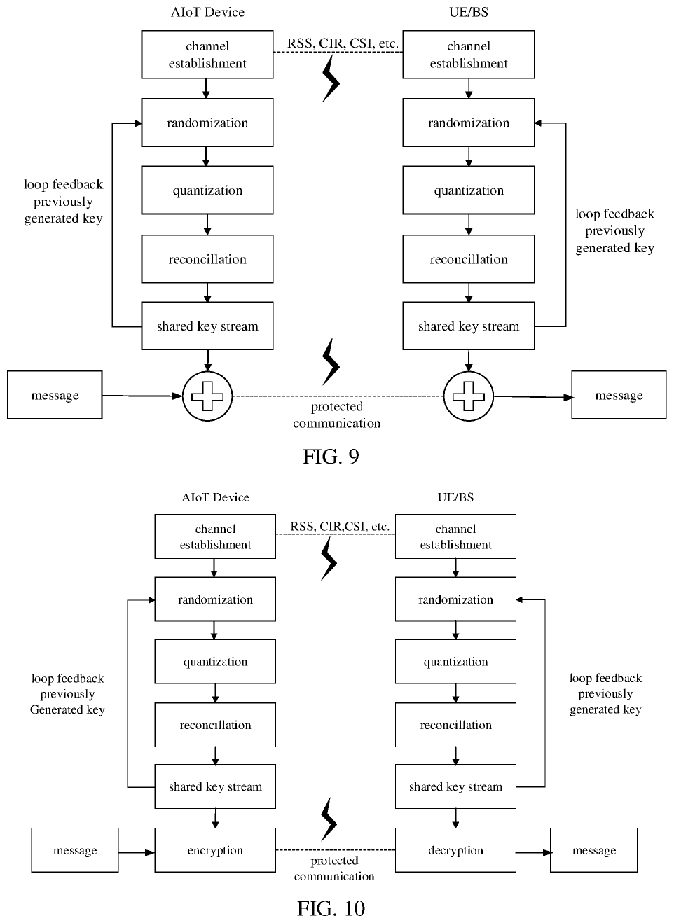

FIG. 9 is an example of a loop feedback physical layer key generation in an AIoT communication system according to an embodiment of the present disclosure. FIG. 10 is an example of a loop feedback physical layer key generation in an AIoT communication system according to an embodiment of the present disclosure.

FIG. 9 and FIG. 10 illustrate that, in some embodiments, an exemplary loop feedback physical layer shared key generation mechanism improves physical layer shared key generation by feeding back the previous generated key as an additional parameter to one of steps in the physical layer key generation process.

Once the keys are generated, they are used as a one-time pad (OTP). OTP can be used in one of several ways, for example, protecting a clear message or information by Exclusive-Oring (XORing) with the OTP to the clear message to form a ciphertext. The OTP can also be used as a key to an encryption algorithm such as advanced encryption standard (AES) to encrypt the clear message into a ciphertext. The ciphertext is then sent over the air.

XOR that refers to exclusive or, exclusive disjunction, exclusive alternation, logical non-equivalence, or logical inequality is a logical operator whose negation is the logical biconditional. With two inputs, XOR is true if and only if the inputs differ (one is true, one is false). With multiple inputs, XOR is true if and only if the number of true inputs is odd. It gains the name “exclusive or” because the meaning of “or” is ambiguous when both operands are true. XOR excludes that case. Some informal ways of describing XOR are “one or the other but not both”, “either one or the other”, and “A or B, but not A and B”.

AES is an encryption algorithm. AES is a block cipher with a block size of 128 bits and a key size of either 128 bits, 192 bits or 256 bits. These three variants are denoted by AES-128, AES-192 and AES-256, respectively.

Using characteristics based on channel reciprocity may require many rounds of channel probing, channel measurements, and channel tuning between the two entities in order to extract common bits. If the extracted common bits are used as long-term shared secret, multiple of 128 bits (e.g., 128 bits or 256 bits) are required. Since the process of extracting bits can be slow, this may require several iterations to extract the required bits. It is a time-consuming luxury that AIoT devices do not have due to their lack of a conventional battery source.

During the AIoT communication cycle, and in the process of communication channel establishment, a key generated from an immediate prior iteration is injected into the key generation process (e.g., randomness generation process). When the physical layer key generation is put into use the first time (i.e., iteration 0), there may not be key generated from prior iteration. In this case, the prior key can be simply initialized to be all O's. In some cases when the AIoT device is pre-configured with a shared key (e.g., a secret key provisioned into the AIoT device that is shared with the system), the shared key can be input into the first iteration of the key generation process. After that, the input into the current iteration of the key generation always uses the key generated from the immediate prior iteration.

Any of the well-known randomization, quantization, and reconciliation techniques can be used in this loop feedback physical layer shared key generation mechanism.

FIG. 9 illustrates an example of loop feedback of a key generated in a prior iteration into the physical layer shared key generation scheme and how the key stream directly as a one-time pad in an AIoT communication system. In details, FIG. 9 illustrates that, a method of wireless communication of an ambient internet-of-things (AIoT) device includes performing a channel establishment procedure with a node (such as UE/BS) through RSS, CIR, channel state information (CSI), etc., obtaining a first physical layer key used in at least one previous communication with the node, inputting the first physical layer key into a physical layer key generator, obtaining a second physical layer key generated based on at least a part of the first physical layer key, generating an encrypted message based on the second physical layer key, and sending the encrypted message to the node.

FIG. 9 illustrates that, a method of wireless communication of a node (such as UE/BS) includes performing a channel establishment procedure with an ambient internet-of-things (AIoT) device through RSS, CIR, channel state information (CSI), etc., obtaining a first physical layer key used in at least one previous communication with the AIoT device, inputting the first physical layer key into a physical layer key generator, obtaining a second physical layer key generated based on at least a part of the first physical layer key, receiving an encrypted message from the AIoT device, and decrypting the encrypted message based on the second physical layer key.

FIG. 9 illustrates that, in some embodiments, the randomization, quantization, and reconciliation operations can be used in this loop feedback physical layer shared key generation mechanism. In some embodiments, the key stream is directly used as a one-time pad in an AIoT communication system.

FIG. 10 illustrates yet another example of loop feedback of a key generated in a prior iteration into the physical layer shared key generation scheme. In this example, the key stream is used as a one-time pad into an encryption process instead of being applied to the message itself. FIG. 10 illustrates that, a method of wireless communication of an ambient internet-of-things (AIoT) device includes performing a channel establishment procedure with a node (such as UE/BS) through RSS, CIR, channel state information (CSI), etc., obtaining a first physical layer key used in at least one previous communication with the node, inputting the first physical layer key into a physical layer key generator, obtaining a second physical layer key generated based on at least a part of the first physical layer key, generating an encrypted message based on the second physical layer key, and sending the encrypted message to the node.

FIG. 10 illustrates that, a method of wireless communication of a node (such as UE/BS) includes performing a channel establishment procedure with an ambient internet-of-things (AIoT) device through RSS, CIR, channel state information (CSI), etc., obtaining a first physical layer key used in at least one previous communication with the AIoT device, inputting the first physical layer key into a physical layer key generator, obtaining a second physical layer key generated based on at least a part of the first physical layer key, receiving an encrypted message from the AIoT device, and decrypting the encrypted message based on the second physical layer key.

FIG. 10 illustrates that, in some embodiments, the randomization, quantization, and reconciliation operations can be used in this loop feedback physical layer shared key generation mechanism. In some embodiments, the key stream is used as a one-time pad into an encryption process instead of being applied to the message itself.

Loop feedback physical layer shared key generation benefits the security of communication between AIoT device and UE/base station in many ways. First, it improves the security of the system by using a previous key as an input for the key generation. Key derivation system basing on a secret key is an effective way to extend the life of keys used in protecting data. Physical layer shared key generation has the additional benefit of keys generated each time is uncorrelated with keys generated at another time. Second, the scheme reduces the time needed to communicate between AIoT device and UE/base station when comparing to traditional devices in order to derive the same number of bits that can be used as shared key. Third, the extracted shared key can be used as a one-time pad (OTP) to protect the information being sent from AIoT device to the UE/base station. OTP provides a very security in that the key stream to protect the communication is never repeated, thus eliminating many attacks that involving collecting and comparing between cipher-text and clear-text pairs. OTP can be used directly over the cleartext by XOR operation or can be used as input into a traditional symmetric encryption algorithm such as AES encryption to protect the cleartext.

Alternative to loop feedback physical layer key generation in an AIoT communication system is to use less efficient physical layer key generation. If a shared key is provisioned into the AIoT device, traditional key derivation techniques (e.g., hashing-based) can be used but would require greater computing capabilities from the AIoT device. Alternative to use one-time pad to protect the communication in an AIoT communication system is to use the shared key in traditionally compute-intensive ciphering or hashing operations that require large-number computation.

Commercial interests for some embodiments are as follows. 1. Solve issues in the prior art. 2. Solve other issues. 3. Provide security of communication between an AIoT device and a node. 4. Provide a good communication performance. 6. Provide high reliability. 7. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as an AIoT device, a node (UE/BS), and/or a communication system. Compatible products follow at least one proposed solution, method, system, and apparatus of some embodiments of the present disclosure. The proposed solution, method, system, and apparatus are widely used in an AIoT device, a node (UE/BS), and/or a communication system. With the implementation of the at least one proposed solution, method, system, and apparatus of some embodiments of the present disclosure, at least one modification to communication methods and apparatus are considered for standardizing.

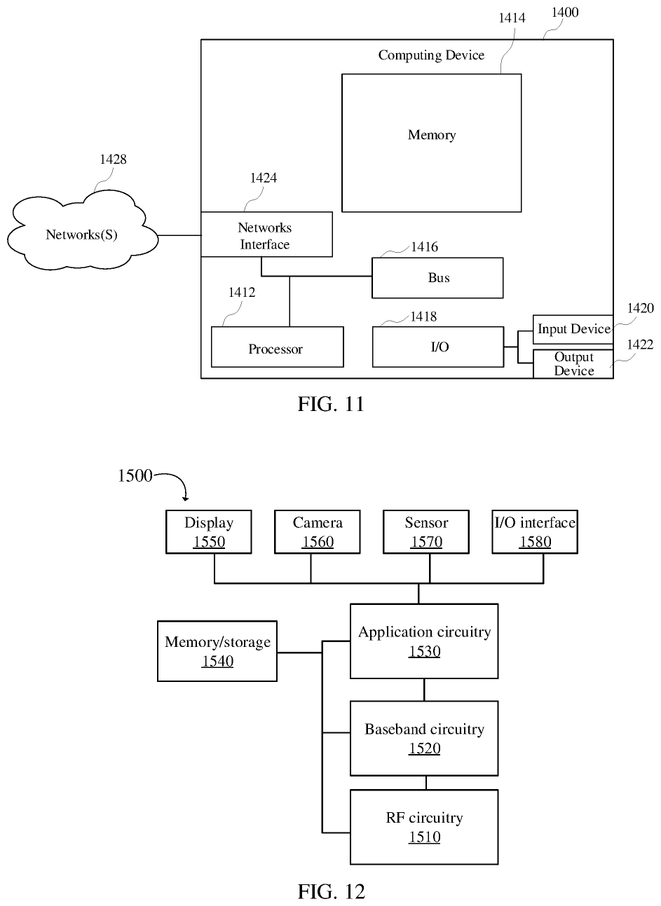

FIG. 11 is an example of a computing device 1400 according to an embodiment of the present disclosure. Any suitable computing device can be used for performing the operations described herein. For example, FIG. 11 illustrates an example of the computing device 1400 that can implement apparatuses and methods of the above embodiments of FIGS. 1 to 10, using any suitably configured hardware and/or software. In some embodiments, the computing device 1400 can include a processor 1412 that is communicatively coupled to a memory 1414 and that executes computer-executable program code and/or accesses information stored in the memory 1414. The processor 1412 may include a microprocessor, an application-specific integrated circuit (“ASIC”), a state machine, or other processing device. The processor 1412 can include any of a number of processing devices, including one. Such a processor can include or may be in communication with a computer-readable medium storing instructions that, when executed by the processor 1412, cause the processor to perform the operations described herein.

The memory 1414 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1400 can also include a bus 1416. The bus 1416 can communicatively couple one or more components of the computing device 1400. The computing device 1400 can also include a number of external or internal devices such as input or output devices. For example, the computing device 1400 is illustrated with an input/output (“I/O”) interface 1418 that can receive input from one or more input devices 1420 or provide output to one or more output devices 1422. The one or more input devices 1420 and one or more output devices 1422 can be communicatively coupled to the I/O interface 1418. The communicative coupling can be implemented via any suitable manner (e.g., a connection via a printed circuit board, connection via a cable, communication via wireless transmissions, etc.). Non-limiting examples of input devices 1420 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1422 include a liquid crystal display (LCD) screen, an external monitor, a speaker, or any other device that can be used to display or otherwise present outputs generated by a computing device.

The computing device 1400 can execute program code that configures the processor 1412 to perform one or more of the operations described above with respect to methods of the above embodiments of FIGS. 1 to 10. The program code may be resident in the memory 1414 or any suitable computer-readable medium and may be executed by the processor 1412 or any other suitable processor.

The computing device 1400 can also include at least one network interface device 1424. The network interface device 1424 can include any device or group of devices suitable for establishing a wired or wireless data connection to one or more data networks 1428. Non limiting examples of the network interface device 1424 include an Ethernet network adapter, a modem, and/or the like. The computing device 1400 can transmit messages as electronic or optical signals via the network interface device 1424.

FIG. 12 is a block diagram of an example of a communication system 1500 according to an embodiment of the present disclosure. Embodiments described herein may be implemented into the communication system 1500 using any suitably configured hardware and/or software. FIG. 12 illustrates the communication system 1500 including a radio frequency (RF) circuitry 1510, a baseband circuitry 1520, an application circuitry 1530, a memory/storage 1540, a display 1550, a camera 1560, a sensor 1570, and an input/output (I/O) interface 1580, coupled with each other at least as illustrated.

The application circuitry 1530 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1500 can execute program code that configures the application circuitry 1530 to perform one or more of the operations described above with respect to methods of the above embodiments of FIGS. 1 to 10. The program code may be resident in the application circuitry 1530 or any suitable computer-readable medium and may be executed by the application circuitry 1530 or any other suitable processor.

The baseband circuitry 1520 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1520 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1510 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1510 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and methods of the above embodiments of FIGS. 1 to 10 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1540 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1580 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1570 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1550 may include a display, such as a liquid crystal display and a touch screen display. In various embodiments, the communication system 1500 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method of key generation by an ambient internet-of-things (AIoT) device, comprising:
obtaining a first physical layer key used in at least one previous communication with a node;
using the first physical layer key as an input of a physical layer key generator; and
obtaining a second physical layer key generated based on at least a part of the first physical layer key, wherein the second physical layer key is an output of the physical layer key generator.

2. The wireless communication method of claim 1, wherein the physical layer key generator is a loop feedback physical layer key generation.

3. The wireless communication method of claim 1, wherein obtaining the second physical layer key comprises preforming a randomization operation, a quantization operation, a reconciliation operation, and a shared key stream operation on the first physical layer key.

4. The wireless communication method of claim 1, wherein the second physical layer key is used as a one-time pad (OTP).

5. The wireless communication method of claim 1, further comprising performing a channel establishment procedure with the node.

6. The wireless communication method of claim 1, further comprising generating an encrypted message based on the second physical layer key.

7. The wireless communication method of claim 6, further comprising sending the encrypted message to the node.

8. The wireless communication method of claim 1, wherein the node is a user equipment (UE) or a base station.

9. A wireless communication method of key generation by a node, comprising:
obtaining a first physical layer key used in at least one previous communication with an ambient internet-of-things (AIoT) device;
using the first physical layer key as an input of a physical layer key generator; and
obtaining a second physical layer key generated based on at least a part of the first physical layer key, wherein the second physical layer key is an output of the physical layer key generator.

10. The wireless communication method of claim 9, wherein the physical layer key generator is a loop feedback physical layer key generation.

11. The wireless communication method of claim 9, wherein obtaining the second physical layer key comprises preforming a randomization operation, a quantization operation, a reconciliation operation, and a shared key stream operation on the first physical layer key.

12. The wireless communication method of claim 9, wherein the second physical layer key is used as a one-time pad (OTP).

13. The wireless communication method of claim 9, further comprising performing a channel establishment procedure with the AIOT device.

14. The wireless communication method of claim 9, further comprising receiving an encrypted message from the AIOT device.

15. The wireless communication method of claim 14, further comprising decrypting the encrypted message based on the second physical layer key.

16. The wireless communication method of claim 9, wherein the node is a user equipment (UE) or a base station.

17. An ambient internet-of-things (AIOT) device, comprising:
a memory;
a transceiver; and
a processor coupled to the memory and the transceiver;
wherein the AIoT device is configured to:
obtain a first physical layer key used in at least one previous communication with an ambient internet-of-things (AIoT) device;
use the first physical layer key as an input of a physical layer key generator; and
obtain a second physical layer key generated based on at least a part of the first physical layer key, wherein the second physical layer key is an output of the physical layer key generator.

18. A node, comprising:
a memory;
a transceiver; and
a processor coupled to the memory and the transceiver,
wherein the processor is configured to:
obtain a first physical layer key used in at least one previous communication with an ambient internet-of-things (AIoT) device;
use the first physical layer key as an input of a physical layer key generator, and
obtain a second physical layer key generated based on at least a part of the first physical layer key, wherein the second physical layer key is an output of the physical layer key generator.
